(19) United States
(12) Patent Application Publication
(10) Pub. No.: US 2012/0134889 A1
(43) Pub. Date: May 31, 2012

(54) Exhaust Treatment Device Insulation System

(76) Inventors: Steven Freis, Ann Arbor, MI (US); William V. Alcini, Ann Arbor, MI (US)

(21) Appl. No.: 12/956,203

(22) Filed: Nov. 30, 2010

(51) Int. Cl. B01D 53/34; B23P 19/00

(52) U.S. Cl. 422/168; 29/700

(57) ABSTRACT

An exhaust treatment device includes an inner shell and an outer shell. Fibrous insulation is positioned within a flexible container. The insulation is compressed 30 to 80 percent by volume. The flexible container is sealed to maintain a compressed state of the insulation. The flexible container and the compressed insulation are positioned between the inner and outer shells of the exhaust treatment device.

### FIELD

The present disclosure relates to an exhaust treatment device including an insulated housing. The insulation is compressed and contained within a sealed flexible container prior to being positioned between portions of the housing.

### BACKGROUND

Exhaust gas treatment devices such as catalytic converters, diesel oxidation catalysts, diesel particulate filters, and the like are employed in various applications to treat exhaust gases emitted from internal combustion engines. Many of the gas treatment devices include inner and outer housings separated by insulation. In order for the exhaust gas treatment devices to properly perform, it may be desirable to compress the insulation materials such that the insulation exerts sufficient force to maintain a desired position during use.

In one configuration, the insulation is shaped as a panel of compressible fibrous material having a free thickness greater than the spacing between the inner and outer housings of the gas treatment device. The resistance of the insulation to movement may be increased by increasing the amount of insulation material in a given space. Alternatively, the free thickness of the insulation may be increased, thereby requiring a greater compression of insulation. Unfortunately, attempts to pack the insulation within a relatively small space may detrimentally deform or shear the insulation during installation. Accordingly, it may be desirable to define an improved exhaust treatment device and method for assembling the exhaust treatment device.

### SUMMARY

This section provides a general summary of the disclosure, and is not a comprehensive disclosure of its full scope or all of its features.

An exhaust treatment device includes an inner shell fixed to an outer shell. Fibrous insulation is positioned within a flexible container. The insulation is compressed 30 to 80 percent by volume. The flexible container is sealed to maintain a compressed state of the insulation. The flexible container and the compressed insulation are positioned between the inner and outer shells of the exhaust treatment device.

A method of assembling an exhaust treatment device includes positioning fibrous insulation within a flexible container, evacuating air from the flexible container and compressing the insulation to reduce its volume 30 to 80 percent. The flexible container is sealed to maintain the compressed shape of the insulation. The flexible container and the compressed insulation are positioned between an inner shell and an outer shell of the exhaust treatment device. The outer shell is fixed to the inner shell.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a cross-sectional view of an exemplary exhaust treatment device;

FIG. 2 is a fragmentary exploded perspective view of the exhaust treatment device;

FIG. 3 is a perspective view of fibrous insulation positioned within a flexible container in a free state;

FIG. 4 is a schematic depicting an apparatus for shaping a container and insulation subassembly of the exhaust treatment device; and

FIG. 5 depicts another apparatus for shaping a container and insulation subassembly of the exhaust treatment device.

Corresponding reference numerals indicate corresponding parts throughout the several views of the drawings.

### DETAILED DESCRIPTION

Example embodiments will now be described more fully with reference to the accompanying drawings.

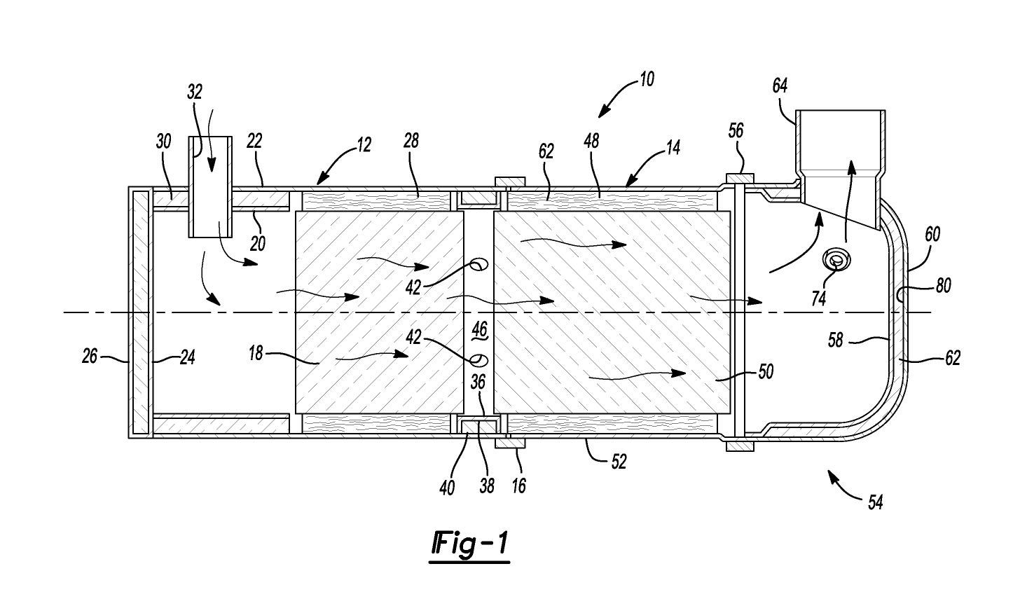

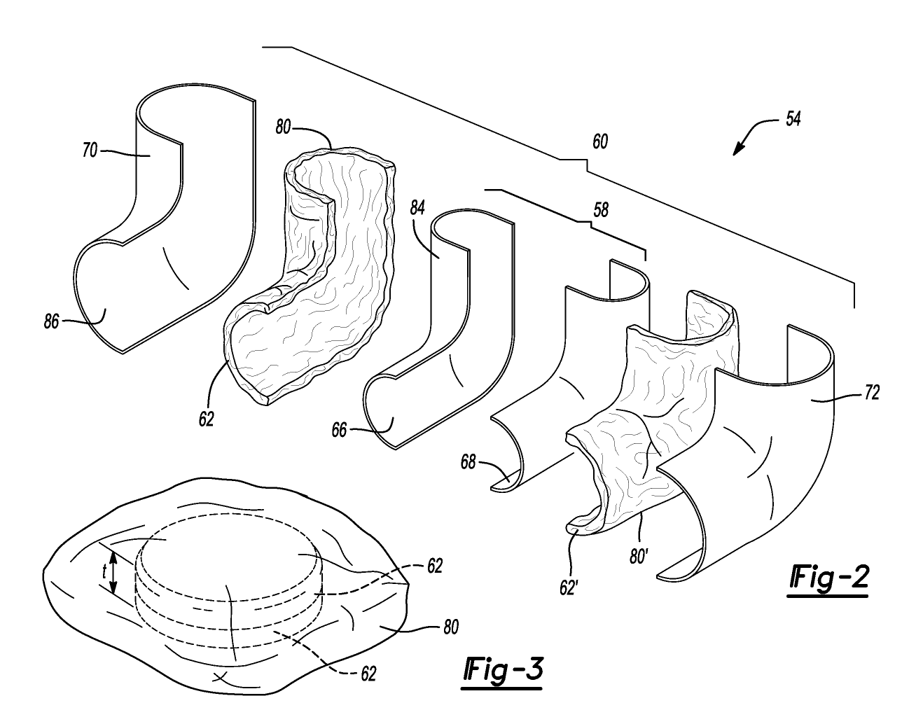

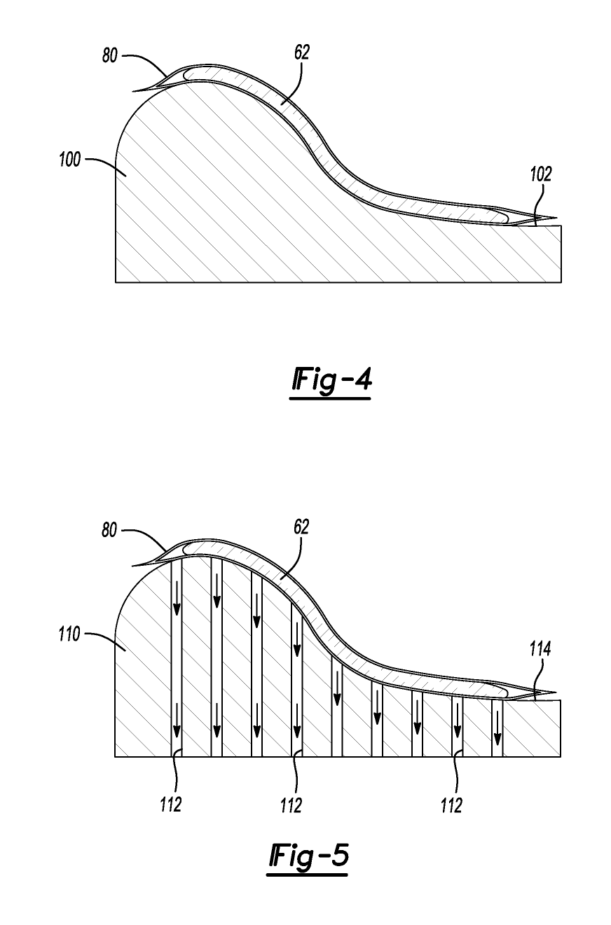

FIGS. 1 and 2 depict an exemplary exhaust treatment device identified at reference numeral 10. Exhaust treatment device 10 includes a diesel oxidation catalyst assembly (DOC assembly) 12 coupled to a diesel particulate filter assembly (DPF assembly) 14 with a clamp 16. DOC assembly 12 includes a ceramic substrate 18, an inner shell 20, an outer shell 22, an inner end plate 24 and an outer end plate 26. A fibrous mat 28 surrounds substrate 18 and is positioned between an outer surface of substrate 18 and an inner surface of outer shell 22. Insulation 30 is positioned between inner shell 20 and outer shell 22 as well as between inner end plate 24 and outer end plate 26. An inlet 32 extends through outer shell 22 and inner shell 20 to provide a passageway for exhaust to enter exhaust treatment device 10.

An insulator ring 36 defines a channel 38 in receipt of insulation 40. A plurality of apertures 42 extend through insulator ring 36 to allow sensors (not shown) to extend into a cavity 46 positioned downstream of substrate 18.

DPF assembly 14 includes a mat 48, a filter element 50, a DPF housing 52, an outlet assembly 54 and a clamp 56. Outlet assembly 54 includes an inner shell 58 coupled to an outer shell 60. A fibrous insulation 62 is positioned between inner shell 58 and outer shell 60. An outlet tube 64 extends through inner shell 58 and outer shell 60 at a position downstream from filter element 50.

As shown in FIG. 2, inner shell 58 may be defined by connecting a first inner shell half 66 to a second inner shell half 68. Similarly, a first outer shell half 70 is fixed to a second outer shell half 72. A portion of outlet tube 64 may be initially associated with first inner shell half 66 while another portion is part of second inner shell half 68. Furthermore, insulation 62 may be formed in two or more sections as indicated at reference numerals 62 and 62′. Another sensor aperture 74 extends through inner shell 58 and outer shell 60 for receipt of a downstream sensor (not shown). When exhaust treatment device 10 is mounted to a vehicle, engine exhaust flows into inlet 32, through substrate 18, through cavity 46, through filter element 50 and exits at outlet tube 64.

A method of assembling exhaust treatment device 10 includes coupling first inner shell half 66 to second inner shell half 68 via a process such as welding. Insulation 62 may be initially provided from a sheet or a roll having a predetermined thickness in a free state, where the free state is defined as an undeformed condition without an external load being applied to the insulation. It is contemplated that insulation 62 may include a low density insulation material having approximately 1200 basis weight. One known insulation material includes Saffil® LDM.

Insulation 62 is cut to size and positioned within a sealable bag in a free state, as shown in FIG. 3. Depending on the thickness of the sheet in the free state, multiple sheets may be stacked on each other, if required. In the example shown, a 12 mm gap exists between inner shell 58 and outer shell 60. Two layers of insulation 62 are stacked on one another to provide a total thickness, t, of approximately 60 mm. The stacked sheets of insulation 62 are positioned within a flexible container 80. Flexible container 80 may include a sealable plastic bag. Air is evacuated from flexible container 80 to reduce the volume of the insulation an amount ranging from 30 to 80 percent.

One method of reducing the insulation volume includes applying a compressive force to an outer surface of flexible container 80. Another method includes applying a vacuum to the interior of flexible container 80. As the air initially within flexible container 80 and between the fibers of insulation 62 is evacuated, the overall thickness of the insulation is reduced. Once a sufficient reduction in thickness has been reached, flexible container 80 is sealed to maintain the vacuum and the reduced insulation thickness. At this time, the insulation and flexible container 80 subassembly may be easily handled, stored or transported to a desired work area.

To continue the assembly process, insulation 62 and flexible container 80 are positioned in engagement with either an outer surface 84 of inner shell 58 or an inner surface 86 of one of first outer shell half 70 and second outer shell half 72. If the design requires, another flexible container 80′ may be filled with compressed insulation 62′. It should be appreciated that the reduced thickness reduction of compressed insulation 62 significantly reduces or eliminates the need to apply a compressive force to insulation 62 when first outer shell half 70 and second outer shell half 72 are spaced from inner shell 58 the desired 12 mm. Once the first outer shell half 70 and the second outer shell half 72 are properly positioned relative to each other and inner shell 58, the shell portions are welded to one another. The likelihood of damaging insulation 62 during installation is reduced. Proper positioning of the insulation is also assured.

While the previous description has been primarily directed to insulation 62, insulation 30 and/or 40 may also be compressed, sealed in a flexible container and installed in a similar manner. It should be appreciated that inner shell 20, outer shell 22, inner shell 58 and outer shell 60 may be sized and shaped differently than depicted in the Figures. The volume of space located between the inner and outer shells may be relatively complex in shape. To further ease assembly of exhaust treatment devices, insulation 30, 40 and/or insulation 62 may be processed to maintain a predetermined shape. In one method, the insulation is positioned within flexible container 80 as previously described. Prior to application of an external force or an internal vacuum, flexible container 80 and insulation are placed on a die 100, shown in FIG. 3, having a surface 102 with a predetermined contour. At this time, air is removed from flexible container 80 and the insulation is compressed while maintaining the desired shape. Flexible container 80 is sealed at this time. Flexible container 80 maintains the predetermined contour. The shape of surface 102 may mimic the shape of the volume between inner shell 58 and outer shell 60.

In an alternate assembly process, the insulation and flexible container 80 may be positioned on a platen 110. Platen 110 includes a plurality of apertures 112 extending therethrough. A vacuum is applied to apertures 112 such that flexible container 80 and insulation 62 are drawn into conformity with an external surface 114 of platen 110. At this time, the air is evacuated from flexible container 80 to reduce the thickness of insulation 62. Once the desired shape has been achieved, flexible container 80 is sealed.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of assembling an exhaust treatment device, comprising:
positioning fibrous insulation within a flexible container;
evacuating air from the flexible container;
compressing the insulation to reduce its volume 30 to 80 percent;
sealing the flexible container to maintain the compressed shape of the insulation; and
positioning the flexible container and compressed insulation between an inner shell and an outer shell of an exhaust treatment device.

2. The method of claim 1 further including obtaining first and second outer shell halves, positioning the flexible container and the insulation between the inner shell and one of the first and second outer shell halves, and fixing the first and second outer shell halves to one another.

3. The method of claim 2 further including positioning another reduced volume of insulation sealed within another flexible container between the inner shell and the other of the first and second outer shell halves.

4. The method of claim 3 further including clamping one of the inner and outer shells to a tubular housing containing one of a diesel particulate filter, a diesel oxidation catalyst and a selective catalytic reduction device.

5. The method of claim 1 wherein the inner shell defines a cavity adapted to receive an exhaust flow from an engine.

6. The method of claim 1 further including melting the flexible container by passing heated gas across an inner surface of the inner shell.

7. The method of claim 6 further including allowing the previously compressed insulation to expand in the absence of a vacuum to fill a cavity between the inner and outer shells.

8. The method of claim 1 further including puncturing the flexible container.

9. The method of claim 8 further including allowing the previously compressed insulation to expand in the absence of a vacuum to fill a cavity between the inner and outer shells.

10. The method of claim 1 further including extending a tube through the inner and outer shells and fixing the tube to one of the inner and outer shells.

11. The method of claim 1 wherein the inner and outer shells include steel sheets.

12. The method of claim 1 wherein the flexible container includes a plastic bag.

13. An exhaust treatment device, comprising:
an inner shell;
an outer shell;
a flexible container; and
fibrous insulation positioned within the flexible container, the insulation being compressed 30 to 80 percent by volume, the flexible container being sealed to maintain a compressed state of the insulation, wherein the flexible container and the compressed insulation are positioned between the inner shell and the outer shell.

14. The exhaust treatment device of claim 13 wherein the outer shell includes a first outer shell half fixed to a second outer shell half.

15. The exhaust treatment device of claim 14 further including a tube extending through the inner and outer shells in fluid communication with a cavity defined by the inner shell.

16. The exhaust treatment device of claim 15 wherein the cavity is adapted to receive an exhaust flow therethrough.

17. The exhaust treatment device of claim 16 further including an exhaust treatment device substrate positioned within a housing, the inner and outer shells being fixed to the housing, wherein the cavity is in fluid communication with the substrate.

18. The exhaust treatment device of claim 13 wherein the insulation and flexible container are shaped to a predetermined contour prior to being positioned between the inner and outer shells.

19. The exhaust treatment device of claim 18 wherein the flexible container is sealed to maintain the predetermined contour.

20. The exhaust treatment device of claim 14 further including another flexible container having compressed insulation therein, the another flexible container being positioned adjacent the flexible container, the another flexible container engaging the first outer shell half and the flexible container engaging the second outer shell half.
